(19) United States
(12) Patent Application Publication
(10) Pub. No.: US 2019/0114581 A1
(43) Pub. Date: Apr. 18, 2019

(54) PROVIDING PACKAGING SOLUTIONS AND THE CORRESPONDING PACKING MATERIALS

(71) Applicant: Sealed Air Corporation (US), Charlotte, NC (US)

(72) Inventors: Brian Vilag, Charlotte, NC (US); Shuk Ling Sze, Southington, CT (US)

(73) Assignee: Sealed Air Corporation (US), Charlotte, NC (US)

(21) Appl. No.: 16/082,811

(22) PCT Filed: Mar. 24, 2017
(86) PCT No.: PCT/US17/23975

§ 371 Date: Sep. 6, 2018

Related U.S. Application Data
(60) Provisional application No. 62/314,569, filed on Mar. 29, 2016.

(51) Int. Cl. G06Q 10/08

(52) U.S. Cl. CPC G06Q 10/0832; B65B 57/20

(57) ABSTRACT

Example embodiments provide methods, apparatus, systems, and computer program products for providing a packaging solution and a corresponding predetermined sequence of packing materials. In one embodiment, a method for controlling one or more packing material making machines is provided. The method comprises storing one or more predetermined packing recipes, wherein a packing recipe comprises (a) machine instructions for making a sequence of one or more packing materials and (b) a packaging solution for positioning the one or more packing materials in a container with an item. One of the one or more predetermined packing recipes is selected based on received input. The method further comprises causing at least one of the packing material making machines is to make the predetermined sequence of one or more packing materials in accordance with the machine instructions of the selected packing recipe and providing the packaging solution to a user through a user interface.

### TECHNOLOGICAL FIELD

Embodiments of the present invention are generally related to methods, systems, computer program products, and apparatus for providing packaging solutions and the corresponding packing materials. Example embodiments relate to providing packaging solutions and corresponding packing materials for foam-in-bag packing materials.

### BACKGROUND

Generally, when a user tries to pack an item in a container (e.g., box, crate, etc.) the user must guess how much packing material to use and how to position the item and the packing material within the container. This can cause the user to engage in a trial and error process to determine how to pack the item within the container. However, the trial and error process may take a significant amount of time and can cause a significant amount of waste. Moreover, depending on the user's packing experience, the protection provided to the item by the packing material may be inconsistent from one user to another. Additionally, an inexperienced user may not pack the item such that the packing material provides the item with sufficient protection.

Therefore, there is a need in the art for methods, systems, computer program products, and apparatus for improving a user's efficiency and effectiveness in packing items in containers.

### SUMMARY

Various embodiments of the present invention provide methods, systems, computer program products, and apparatus for providing packaging solutions and corresponding predetermined sequence of packing materials to a user. For example, various embodiments may be configured to provide packaging solutions for packing one or more items using foam-in-bag packing materials and control a machine for making a predetermined sequence of foam-in-bag packing materials.

According to one aspect of the present invention, an apparatus for controlling one or more packing material making machines is provided. In an example embodiment, the apparatus comprises at least one processor and at least one memory storing computer program code. The at least one memory and the computer program code are configured to, with the processor, cause the apparatus to at least store one or more predetermined packing recipe. A packing recipe comprises (a) machine instructions for making a predetermined sequence of one or more packing materials and (b) a packaging solution for positioning the one or more packing materials in a container with an item. The at least one memory and the computer program code are further configured to, with the processor, cause the apparatus to at least select one of the one or more predetermined packing recipes based on received input; cause a packing material making machine to make the sequence of one or more packing materials in accordance with the machine instructions of the selected packing recipe; and provide the packaging solution to a user through a user interface.

According to another aspect of the present invention, a method for controlling one or more packing material making machines. In an example embodiment, the method comprises storing one or more predetermined packing recipes. A packing recipe comprises (a) machine instructions for making a predetermined sequence of one or more packing materials and (b) a packaging solution for positioning the one or more packing materials in a container with an item. The method further comprises selecting one of the one or more predetermined packing recipes based on received input; causing at least one of the packing material making machines to make the sequence of one or more packing materials in accordance with the machine instructions of the selected packing recipe; and providing the packaging solution to a user through a user interface.

According to yet another aspect of the present invention, a computer program product for controlling one or more packing material making machines. In an example embodiment, the computer program product comprises at least one non-transitory computer-readable storage medium having computer-executable program code instructions stored therein. The computer-executable program code instructions comprise program code instructions configured to store one or more predetermined packing recipes. A packing recipe comprises (a) machine instructions for making a predetermined sequence of one or more packing materials and (b) a packaging solution for positioning the one or more packing materials in a container with an item. The computer-executable program code instructions further comprise program code instructions configure to select one of the one or more predetermined packing recipes based on received input; cause at least one of the packing material making machines to make the sequence of one or more packing materials in accordance with the machine instructions of the selected packing recipe; and provide the packaging solution to a user through a user interface.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention;

FIG. 2 is a block diagram of a packaging solution system, in accordance with various embodiments of the present invention;

FIG. 3 provides a flowchart of various processes and procedures for providing a packaging solution and the corresponding packing materials, in accordance with various embodiments of the present invention;

FIG. 4 illustrates an example screen view of a user interface for providing a packaging solution, in accordance with various embodiments of the present invention;

FIG. 5 provides a flowchart of various processes and procedures for editing a packing recipe, in accordance with various embodiments of the present invention; and

FIG. 6 provides a flowchart of various processes and procedures for creating a new packing recipe, in accordance with various embodiments of the present invention.

### DETAILED DESCRIPTION OF VARIOUS EMBODIMENTS

Various embodiments of the present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### I. GENERAL OVERVIEW

Various embodiments of the present invention are directed to providing a user with a packaging solution and at least a portion of the packing materials needed to implement the packaging solution. For example, the packaging solution may comprise instructions for using a predetermined sequence of one or more packing materials to pack an item. Example embodiments of the present invention may further control a packing material making machine to make the predetermined sequence of packing materials. In some embodiments, the packing materials are foam-in-bag packing materials and the packing material making machine is a foam-in-bag packing material making machine. In an example embodiment, making packing materials may comprise mixing elements of the packing materials; confining one or more elements of the packing materials within a plastic and/or polymer bag and/or enclosure; forming packing materials of a particular shape, size, consistency, having particular cushioning properties, and/or the like; and/or the like. In an example embodiment, a packing material may be any material used in cushioning one or more items being shipped, stored, enclosed, and/or the like within a container (e.g., box, crate, and/or the like) and/or configured to fill at least a portion of excess space within a container being used to ship, store, enclose, and/or the like one or more items.

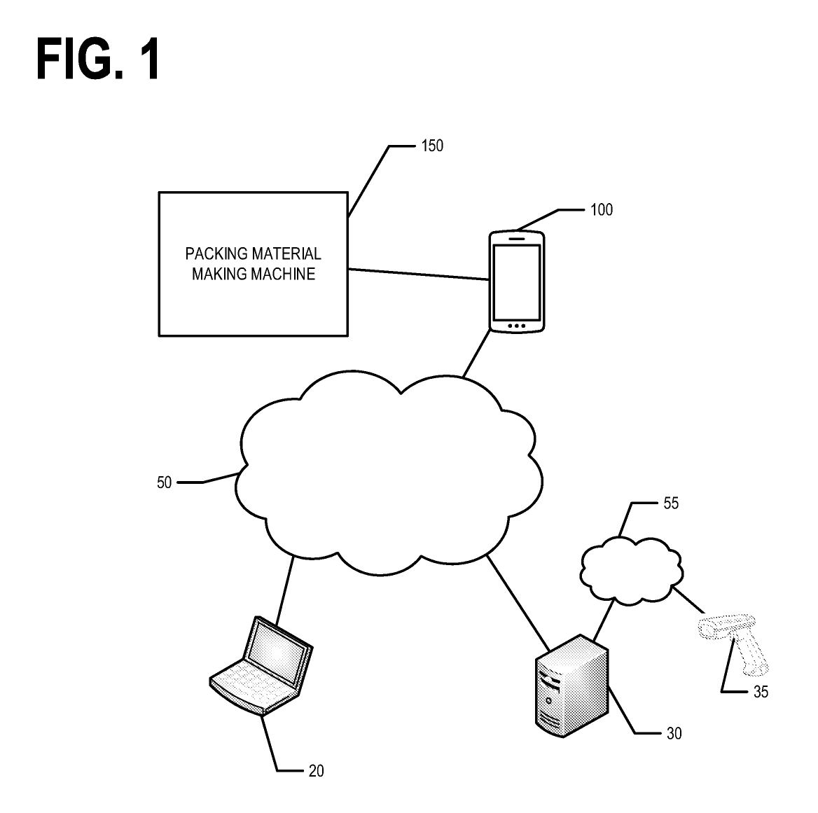

FIG. 1 illustrates an example embodiment of a system that may implement the present invention. In the illustrated embodiment, the system may include one or more control computing entities 100, one or more packing material making machines 150, one or more expert devices 20, and one or more package control systems 30. The one or more control computing entities 100, one or more expert devices 20, and one or more package control systems 30 may communicate with each other and/or a variety of other computing entities via one or more wired or wireless networks, such as networks 50, 55. In an example embodiment, a package control system 30 may be in wired or wireless communication with one or more scanners 35 (e.g., barcode scanners, optical scanners, computer vision devices, and/or the like) via wired or wireless network 55 (e.g., a 3G network, the Internet, an internal network, a proprietary network, a secured network, and/or the like).

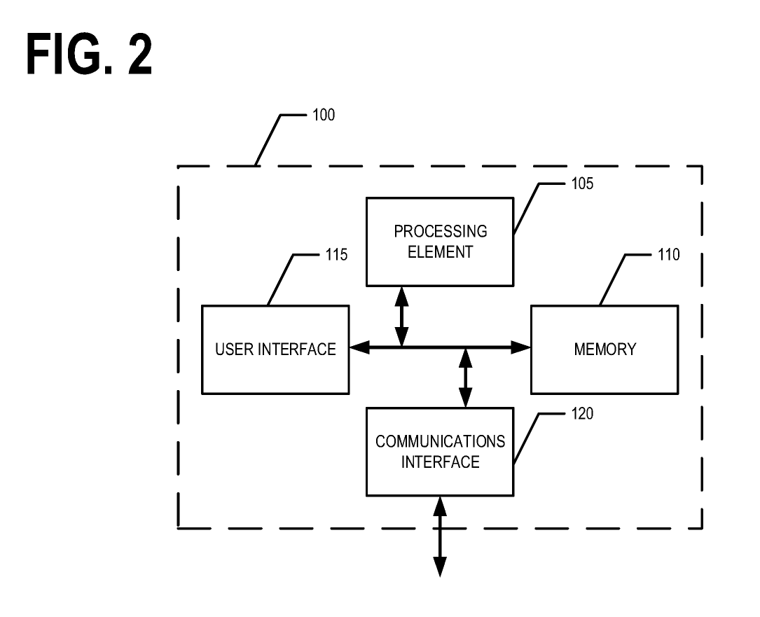

FIG. 2 provides a block diagram of an example control computing entity 100. For example, a control computing entity 100 may comprise a processing element 105, memory 110, a user interface 115, a communications interface 120, and/or the like. The control computing entity 100 may be in direct wired or wireless communication with one or more packing material making machines 150. In an example embodiment, the control computing entity 100 is an integrated part of the packing material making machine 150 and performs various functions as the controller thereof. For example, the control computing entity 100 may receive signals from one or more sensors of the packing material making machine 150, provide machine instructions to the packing material making machine 150 such that the packing material making machine makes one or more packing materials of a predetermined sequence of packing materials, and/or the like. For example, example embodiments the packing material making machine 150 may comprise a combination of sensors used to determine if the packing material making machine is finished making a current packing material, ready to make a next packing material, and/or the like. In an example embodiment, one of the sensors may be a foot switch that the user may operate to provide various input, as described elsewhere herein. In various embodiments, the sensors may comprise one or more infrared (IR) sensors, optical sensors, Hall Effect sensors, capacitive sensors, limit switches, pressure sensors, electrical current sensors, and/or the like. In example embodiments, the packing materials are foam-in-bag packing materials. Example embodiments of a control computing entity 100 are described in more detail elsewhere herein.

Various embodiments of the present invention will now be described with more detail.

### II. EXEMPLARY SYSTEM OPERATION

In various embodiments, the control computing entity 100 is configured to provide a user with a packaging solution for packing an item in a box, crate, or other container and controlling a packing material making machine to provide a predetermined sequence of one or more packing materials (e.g., foam-in-bag packing materials) for use in packing the item in the container in accordance with the packaging solution.

### Providing a Packaging Solution and the Corresponding Sequence of Packing Materials

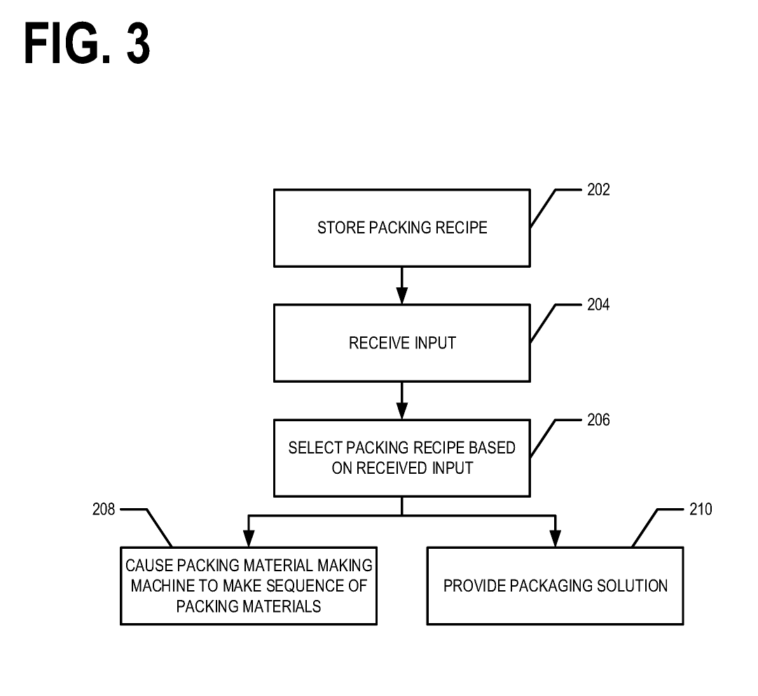

FIG. 3 provides a flowchart for providing a packaging solution and the corresponding sequence of packing materials. Starting at block 202, one or more packing recipes are stored. For example, the control computing entity 100 may store one or more packing recipes. For example, the control computing entity 100 may comprise memory 110 or the like configured for storing one or more packing recipes. In other example embodiments, one or more packing recipes may be stored by expert device 20, package control system 30, or other computing device in communication with network 50, in addition to and/or in place of the packing recipe(s) being stored locally by the control computing entity 100. In such example embodiments, the control computing entity 100 may request a packing recipe from the expert device 20, package control system 30, or other computing device, as appropriate, and receive the recipe in volatile memory for execution of the packing recipe.

In example embodiments, each packing recipe comprises machine instructions for making a predetermined sequence of one or more packing materials and a packaging solution for positioning the one or more packing materials in a container with an item. In various embodiments, the machine instructions may be configured to control the packing material making machine 150 to make the predetermined sequence of one or more packing materials. In example embodiments, the packaging solution may comprise step-by-step illustrated directions, a video, and/or the like for instructing a user how to pack an item in a box, crate, or other container using a predetermined sequence of packing material. The packing recipe may further comprise a packing recipe identifier configured to identify the packing recipe, one or more item identifiers configured to identify one or more items that may be packed using the packing recipe, a container identifier configured to identify a particular type of box, crate, or other container for the item to be packed in, and/or the like.

At block 204, input is received. For example, the control computing entity 100 may receive input. For example, the control computing entity may comprise a processing element 105, user interface 115, communications interface 120, and/or the like configured for receiving input. For example, the input may indicate an item to be packed. For example, the input may comprise an item identifier, be a selection of an item, and/or the like. In an example embodiment, the control computing entity 100 may receive input from the packaging control system 30 comprising an item identifier and/or otherwise indicating an item that is to be packed. For example, a scanner 35 (e.g., barcode scanner, optical scanner, computer vision system, and/or the like) may scan the item (e.g., scan the item and/or a barcode or other machine-readable indicia associated with the item) and provide scan information/data to the packing control system 30. The packing control system 30 may then use the scan information/data to identify an item and/or the corresponding item identifier for an item that is to be packed. The packing system 30 may then provide input comprising the item identifier and/or otherwise identifying the item to be packed. In another example, the control computing entity 100 may be in communication wired and/or wireless communication with a scanner 35 (e.g., through network 50, a direct connection, and/or the like). The control computing entity 100 may receive scan information/data from the scanner 35 (e.g., scan of a barcode or other machine-readable indicia, computer vision information/data, and/or the like) that may be used to identify the item and/or corresponding item identifier for an item that is to be packed. In yet another example, a user may press or select a button (hard or soft) or operate a foot switch to provide input indicating an item to be packed. In another example, the input may indicate a desired packing recipe. For example, a user may provide input (e.g., pressing or selecting a hard or soft button or operating a foot switch) to indicate a desired packing recipe.

At block 206, a packing recipe is selected based on and/or in response to the received input. For example, the control computing system 100 may select a packing recipe based on and/or in response to the received input. For example, the control computing system 100 may comprise a processing element 105 configured for selecting a packing recipe based on and/or in response to the received input. For example, if the received input comprises an item indicator, a packing recipe comprising and/or associated with the item identifier is identified and/or selected. In another example, if the received input indicates an item, the corresponding item identifier may be identified and/or determined and a packing recipe comprising and/or associated with the item identifier is identified and/or selected. In yet another example, if the received input indicates a desired packing recipe, the indicated packing recipe may be selected. For example, the selected packing recipe may be accessed from memory 110, and/or the like.

At block 208, the machine instructions of the selected packing recipe may be provided to the packing material making machine and cause the packing material making machine to make a predetermined sequence of one or more packing materials. For example, the control computing entity 100 may provide the machine instructions of the selected packing recipe to the packing material making machine 150, thereby causing the packing material making machine to make a predetermined sequence of one or more packing materials, in accordance with the packing recipe. For example, the control computing entity 100 may comprise a processing element 105, communications interface 120, and/or the like for providing the machine instructions to the packing material making machine 150, thereby causing the packing material making machine to make a predetermined sequence of one or more packing materials. For example, the packing material making machine 150 may make a sequence of one or more foam-in-bag packing materials. In the example of foam-in-bag packing materials, the machine instructions may comprise information regarding the number of bags to be made, any delay between consecutive bags, how full each bag should be (e.g., the amount of liquid foam to be dispensed into the bag), and/or the like. As will be described in more detail below, one or more of the predetermined sequence of packing materials may be made and provided approximately simultaneously with an instruction regarding how the provided packing material should be used to pack the item.

At block 210, the packaging solution is provided, for example, to a user. For example, the control computing entity 100 may provide the packaging solution. For example, the control computing entity 100 may comprise a processing element 105, user interface 115, and/or the like configured for providing the packaging solution. For example, the packaging solution may be provided as click through step-by-step instructions. The steps of the instructions may be illustrated with diagrams, pictures, videos, and/or the like. In some embodiments, the packaging solution is provided as a video.

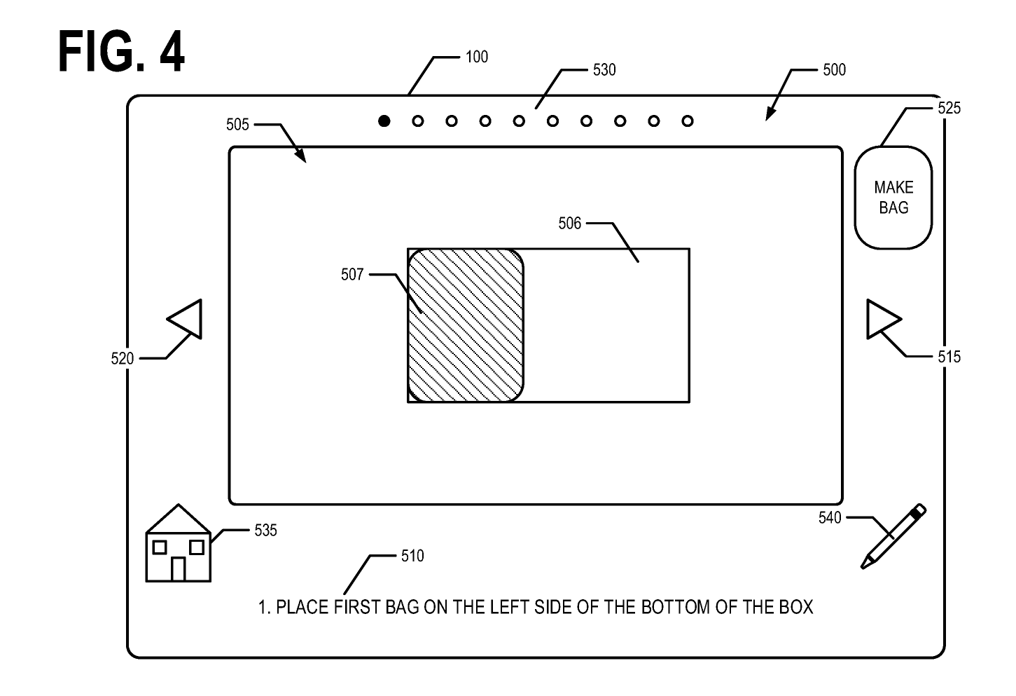

FIG. 4 illustrates an example graphical user interface (GUI) 500 view of a control computing entity 100 providing a packaging solution, according to an embodiment of the present invention. In particular, the GUI 500 may comprise an illustration/video portion 505, written instructions 510, forward arrow 515, back arrow 520, make bag button 525, status indicator 530, home button 535, edit button 540, and/or the like. In various embodiments, the written instructions 510 may comprise a written description of the step to be completed and the illustration/video portion 505 may provide a diagram, picture, or video illustrating the instructions. For example, the illustrated instructions say that a bag (e.g., a foam-in-bag packing material) should be placed on the left side of the bottom of the box and the illustration/video portion 505 shows a box 506 with a bag 507 (e.g., a foam-in-bag packing material) on the left side of the bottom of the box. In other examples, the instructions 510 may instruct a user to get and/or set up a particular box, crate or other container (e.g., the container identified by the container identifier of the packing recipe); to place a sequence of one or more packing materials in the container in a particular way; to place one or more items in the container in a particular way; to place one or more fliers, brochures, instruction booklets or pamphlets, invoices, packing lists, promotional items, and/or the like in the container; to secure the top of the container; to seal the container; and/or the like. In particular, the written instructions 510 and/or the illustrated instructions provided in the illustration/video portion 505 of the GUI 500 may provide various instructions for packing the item using the predetermined sequence of one or more packing materials.

The forward arrow 515 may be configured to allow a user to select the forward arrow 515 and have the next step of the packaging solution be displayed. In some embodiments, a user may operate a foot switch to have the next step of the packaging solution be displayed. The back arrow 520 may be configured to allow a user to select the back arrow and have the previous step of the packaging solution be displayed. The home button 535 may be configured to allow a user to select the home button 535 and have the home menu for the control computing entity 100 displayed (e.g., a screen where an item and/or packing recipe may be selected, or from which other actions may be taken). The edit button 540 may be configured to allow a user to edit the packaging solution, as will be described in more detail elsewhere herein. The status indicator 530 may be configured to indicate where in the packaging solution the displayed step is. For example, each circle of the status indicator 530 may represent a step of the packaging solution and the status indicator 530 may indicate which step is currently being displayed. For example, the one filled circle of the illustrated status indicator 530 may indicate that the first step is currently being displayed.

Various embodiments comprise a make bag button 525. For example, the user may press or select the make bag button 525 to cause the packing material used in the currently displayed step to be made. In some embodiments, the user may operate a foot switch to provide input to cause the packing material in the currently displayed step to be made or to override a programmed delay between the making of consecutive packing materials of the sequence of packing materials. In another embodiment, the control computing entity 100 may automatically cause the packing material making machine 150 to make the packing material used in a particular step when the step is displayed. For example, the control computing entity 100 may cause a particular packing material from the sequence of one or more packing materials to be made in response to displaying an instruction step in which the particular packing material is used. In such an embodiment, the user may select the make bag button 525 (or operate a foot switch) if for some reason the user needs that bag to be remade for any reason. In another embodiment, the control computing entity 100 may be configured to cause the packing material making machine 150 to make the sequence of packing materials with predetermined delays between the making of particular packing materials. For example, the control computing entity 100 may cause the packing material making machine 150 to make a first packing material and then to wait a predetermined number of seconds (e.g., three seconds, six seconds) before beginning to make a second packing material. For example, the predetermined delay may be determined such that it is expected that the user will be ready to use the second packing material as soon as or shortly after it is available. In another example, the predetermined delay may be determined such that is expected that the user will not need to wait for a substantial amount of time for the second packing material to be made and/or provided once the user is ready to use the second packing material. In embodiments wherein the packing material is a foam-in-bag packing material, the timing of providing the packing material may be especially important as the foam-in-bag packing material must be placed within a particular time window while the foam is expanding and may be molded about the item. Thus, in various embodiments, one or more packing materials of the predetermined sequence of packing materials are made by the packing material making machine 150 as the user is expected to be ready to use the packing materials. For example, one or more packing materials of the predetermined sequence of packing materials may be made and/or provided by the packing material making machine 150 and the corresponding packaging solution (e.g., comprising instructions regarding how to use the packing material to pack the item(s)) may be provided to the user approximately simultaneously. For example, a packing material of the predetermined sequence of packing materials may be provided by the packing material making machine 150 approximately simultaneously as the instructions for using the packing material are displayed by the user interface 115. The user may then pack the item in the container using the sequence of predetermined packing materials in accordance with the packaging solution.

### Editing a Packing Recipe

As indicated above, the user may press or select an edit button 540 (hard or soft) and/or the like to edit a packing recipe. In some embodiments, only authorized users are allowed to edit packing recipes or to edit certain portions of packing recipes (e.g., the machine instructions, the packaging solution written instructions, the illustrated instructions). For example, a user may need to provide authorized log in credentials, key enter or otherwise provide an authorizing passcode, be identified through bioinformatics, be identified by a radio frequency identification (RFID) tag within the user's ID badge, and/or the like to edit a packing recipe. In other embodiments, any user may edit a packing recipe.

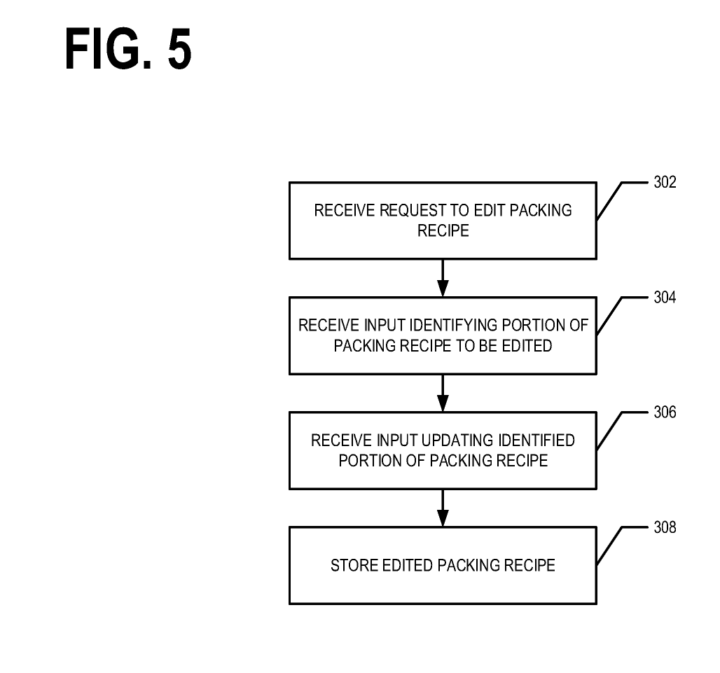

FIG. 5 provides a flowchart of editing a packing recipe, in accordance with example embodiments of the present invention. Starting at block 302, a request to edit a packing recipe is received. For example, the control computing entity 100 may receive a request for editing a packing recipe. For example, the control computing entity 100 may comprise a user interface 115 and/or the like configured to receive a request for editing a packing recipe. For example, the user may press or select the edit recipe button 540.

At block 304, input is received identifying the portion of the packing recipe to be edited. For example, the control computing entity 100 may receive input identifying the portion of the packing recipe to be edited. For example, the control computing entity 100 may comprise a processing element 105, user interface 115, and/or the like for receiving input identifying the portion of the packing recipe to be edited. For example, the input may indicate that the user wishes to edit the machine instructions for making the sequence of packing materials (e.g., how full a particular foam-in-bag packing material is, the delay between two consecutive packing materials being made, and/or the like). In another example, the input may indicate that the user wishes to edit the written instructions of a packaging solution. In another example, the input may indicate that the user wishes to replace and/or edit the video and/or one or more illustrations of the packaging solution. In another example, the container identifier may need to be updated, a new item identifier may need to be added to the packing recipe, and/or the like.

At block 306, input updating the identified portion of the packing recipe is received. For example, the control computing entity 100 may receive input updating the identified portion of the packing recipe. For example, the control computing entity 100 may comprise a processing element 105, user interface 115, and/or the like configured for receiving input updating the identified portion of the packing recipe. For example, if the identified portion is the sequence of one or more packing materials, the received input may update the order of the sequence of one or more packing materials, the delay between making two particular packing materials, how the size of a particular packing material, and/or the like. In the example of foam-in-bag packing material, the input may update the amount of liquid foam dispensed in one or more of the packing materials, and/or the like. If the identified portion of the packing recipe is the written instructions or particular step in the written instructions, the text of the written descriptions may be updated by the received input. If the identified portion of the packing recipe is a step illustration or video, a new step illustration or video may be uploaded or selected by the received input. In other embodiments, input providing a new item identifier, an updated container identifier, and/or the like may be received.

At block 308, the edited packing recipe is stored. For example, the control computing entity 100 may store the edited packing recipe. For example, the control computing entity 10 may comprise memory 110 and/or the like for storing the edited packing recipe. In an example embodiment, the packing recipe may comprise an update log and the update log may be updated to indicate that the packing recipe was edited, indicate the edits that were made, indicate the user who did the editing, and/or the like. In various embodiments, the update to the packing recipe may be provided to the expert device 20, package control system 30, or other computing device in communication with network 50 and stored thereby. In some such embodiments, the update to the packing recipe may be provided to and stored by the expert device 20, package control system 30, or other computing device in place of and/or in addition to storing the update to the packing recipe by the control computing entity 100. In the future, when the edited packing recipe is selected, the packaging solution and the corresponding sequence of packing materials will be provided in accordance with the updated packing recipe.

### Creating a New Packing Recipe

For various reasons, a user may wish to create a new packing recipe. For example, a new item may need to be packaged. In another example, a container may no longer be available and a new recipe may be created for packing an old item in a new container. In some embodiments, a new packing recipe may be created by an expert (e.g., someone with considerable experience with packing various items using one or more packing materials). The expert may use an expert device 20 to create a new packing recipe and provide the new packing recipe to the control computing entity 100 by a wireless network (e.g., Wi-Fi, Bluetooth, and/or the like) or a wired connection (e.g., via a USB connection, from a portable flash memory drive, and/or the like). For example, a new recipe may be determined and/or created outside of the normal operational conditions (e.g., in a lab, in a training session, and/or the like). Thus, a user who is qualified to determine and/or create a new packing recipe (e.g., an expert) may determine and/or create a new packing recipe. The example of an expert operating an expert device 20 to create a new packing recipe is provided below. It should be understood that a new packing recipe may be created and/or determined by various users and/or using the control computing entity 100, as appropriate.

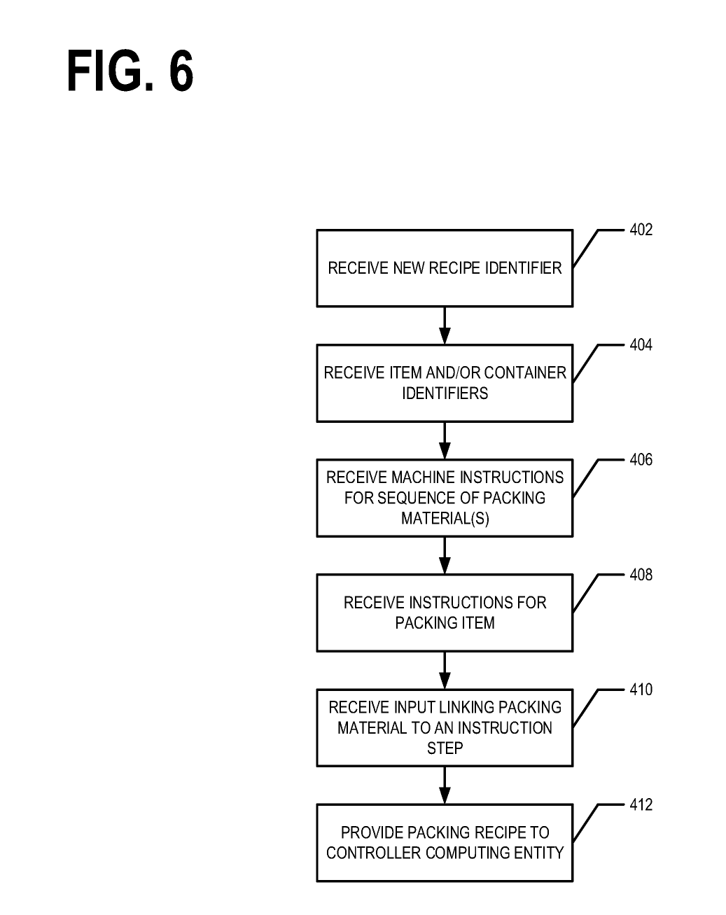

FIG. 6 provides a flowchart for creating a new packing recipe, in accordance with example embodiments of the present invention. Starting at block 402, a new recipe identifier is received. For example, an expert device 20 may receive input comprising a new recipe identifier. In various embodiments, the new recipe identifier may be a name (e.g., Widget A Recipe), an alpha numeric code, an image (e.g., a picture of Widget A), and/or the like.

At block 404, item and/or container identifiers are received. For example, an expert device 20 may receive input comprising and/or selecting item identifiers and/or container identifiers. For example, input comprising and/or selecting one or more items that the new packing recipe may be used to package may be received. For example, a new packing recipe assigned the name Widget A Recipe, input providing the item identifier for widget A and/or a container identifier identifying a container that widget A should be packed in may be received. For example, input comprising a container identifier and/or selecting a container that should be used to pack one or more items in accordance with the packaging solution may be received.

At block 406, machine instructions for making a sequence of one or more packing materials are received. For example, the expert device 20 may receive input comprising machine instructions for making a sequence of one or more packing materials. For example, the machine instructions may be configured to control the packing material making machine 150 to make a predetermined sequence of one or more packing materials. The expert (e.g., operating the expert device 20) may determine the sequence of one or more packing materials based on the item to be packaged, the container the item is to be packaged in, the level of protection intended to be provided to the item, and/or the like. In an example embodiment, the sequence of one or more packing materials may be determined based on a series of tests to ensure the item is being sufficiently protected by the packing materials. For example, a drop test or other test may be used to determine if the level of protection provided by the sequence of packing materials and the packaging solution is sufficient to protect the item.

At block 408, instructions for packing the item may be received. For example, the expert device 20 and/or control computing entity 100 may receive instructions for packing the item. For example, the expert may capture a video of how to pack an item in a container using the predetermined sequence of one or more packing materials. The expert may provide the video in its entirety, edit the video into small clips (e.g., each instruction may be shown by a small clip) and provide the small clips, capture still images from the video and provide the still images, and/or the like. In some embodiments, the expert may provide written text describing each step. For example, the expert (e.g., operating the expert device 20) may type written step-by-step instructions which may or may not be spoken, recited, and/or otherwise audibly provided in a corresponding video.

At block 410, input is received linking at least one of the packing materials of the sequence of one or more packing materials to a particular step. For example, the expert device 20 may receive input linking at least one of the packing materials of the sequence of one or more packing materials to a particular step. For example, input may be received linking the first packing material of the predetermined sequence of packing materials to the second step and the second packing material of the predetermined sequence of packing materials to the fifth step. Thus, if a packing material is to be made automatically when the user accesses the instruction step for using that packing material, the first packing material may be made when the second step is displayed (e.g., in response thereto) and the second packing material may be made when the fifth step is displayed (e.g., in response thereto). If the user must press or select the make bag button 525 (or operate a foot switch) at a particular step to make the next packing material, the packing material linked to the displayed step may be made in response to the user selecting or pressing the make bag button 525 (or operating the foot switch). In an example embodiment, if a packing material is not linked to a particular step, the make bag button 525 may not be provided and/or may not be selectable when the particular step is displayed. Thus, in an example embodiment, the user may only be able to request a packing material be made when a step in which a packing material is used is displayed.

At block 412, the new packing recipe is provided to the control computing entity 100. For example, if the new packing recipe is created on the expert device 20, the control computing entity 100 may receive and store the new packing recipe. For example, the control computing entity 100 may receive the new packing recipe via a wired or wireless network (e.g., LAN, Wi-Fi, Bluetooth, and/or the like). In another example, the packing recipe may be uploaded onto the control computing entity 100 using a USB flash drive and/or the like. The control computing entity 100 may then store the received new packing recipe (e.g., in memory 110). In various embodiments, a packing recipe may not be stored locally by the control computing entity 100. Rather, the control computing entity 100 may request a packing recipe from the expert device 20, package control system 30, or other computing device in communication with network 50. In such embodiments, the new packing recipe may not be provided to the control computing entity 100 until the packing recipe is requested by the control computing entity 100. The packing recipe may be provided to an appropriate computing device to be stored.

### III. EXEMPLARY SYSTEM ARCHITECTURE

### 1. Exemplary Control Computing Entity

FIG. 2 provides a schematic of a control computing entity 100 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, televisions, dongles, cameras, wristbands, wearable items, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In an example embodiment, a control computing entity 100 is a tablet coupled to a packing material making machine 150. In another example embodiment, a control entity provides a touchscreen user interface and controller for a packing material making machine 150.

The control computing entity 100 may also comprise, be in communication with, and/or be associated with various other systems, such as a packaging control system 30, an expert computing device 20, and a variety of other systems and their corresponding components.

As indicated, in one embodiment, the control computing entity 100 may also include one or more communications interfaces 120 for communicating with various computing entities, such as by communicating data, content, information, and/or similar terms used herein interchangeably that can be transmitted, received, operated on, processed, displayed, stored, and/or the like.

As shown in FIG. 2, in one embodiment, the control computing entity 100 may include or be in communication with one or more processing elements 105 (also referred to as processors, processing circuitry, and/or similar terms used herein interchangeably) that communicate with other elements within the control computing entity 100 via a bus, for example. As will be understood, the processing element 105 may be embodied in a number of different ways. For example, the processing element 105 may be embodied as one or more complex programmable logic devices (CPLDs), microprocessors, multi-core processors, coprocessing entities, application-specific instruction-set processors (ASIPs), microcontrollers, and/or controllers. Further, the processing element 105 may be embodied as one or more other processing devices or circuitry. The term circuitry may refer to an entirely hardware embodiment or a combination of hardware and computer program products. Thus, the processing element 105 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 105 may be configured for a particular use or configured to execute instructions stored in volatile or non-volatile media or otherwise accessible to the processing element 105. As such, whether configured by hardware or computer program products, or by a combination thereof, the processing element 105 may be capable of performing steps or operations according to embodiments of the present invention when configured accordingly.

In one embodiment, the control computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 110, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In example embodiments, the control computing entity 100 comprises memory 110. The memory 110 may comprise volatile memory and/or non-volatile memory.

In one embodiment, the control computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 110, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 105. Thus, the databases, database instances, database management systems, data, applications, programs, program modules, scripts, source code, object code, byte code, compiled code, interpreted code, machine code, executable instructions, and/or the like may be used to control certain aspects of the operation of the control computing entity 100 with the assistance of the processing element 105 and operating system.

As indicated, in one embodiment, the control computing entity 100 may also include one or more communications interfaces 120 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the control computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

The control computing entity 100 may include or be in communication with a user interface 115. The user interface 115 may comprise one or more input elements, such as a keyboard input, a mouse input, a touch screen/display input, motion input, movement input, audio input, pointing device input, joystick input, keypad input, scanner 35, foot switch, and/or the like. The user interface 115 may also include or be in communication with one or more output elements (not shown), such as audio output, video output, screen/display output, motion output, movement output, and/or the like.

As will be appreciated, one or more of the control computing entity's 100 components may be located remotely from other control computing entity 100 components, such as in a distributed system. Furthermore, one or more of the components may be combined and additional components performing functions described herein may be included in the control computing entity 100. Thus, the control computing entity 100 can be adapted to accommodate a variety of needs and circumstances. As will be recognized, these architectures and descriptions are provided for exemplary purposes only and are not limiting to the various embodiments.

### 2. Exemplary Expert Device

In one embodiment, an expert may be someone with considerable experience with packing various items using one or more packing materials. In particular, an expert may be responsible for determining a packaging solution for packing one or more items into a box, crate, or other container. An expert device 20 may include one or more components that are functionally similar to those of the control computing entity 100. For example, in one embodiment, each expert device 20 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, an expert device 20 may communicate or interact with any number of control computing entities 100 via their respective communication interfaces. As will be recognized, these architectures and descriptions are provided for exemplary purposes only and are not limiting to the various embodiments.

### 3. Packaging Control System

In one embodiment, a packaging control system 30 may be configured to organize a flow of one or more items to be packaged. For example, the packaging control system 30 may be configured to provide a picking list to one or more employees for picking items to be packaged (e.g., picking the items from a warehouse, etc.), control one or more picking machines for picking items to be packaged, control one or more conveyor belts or other item transporting devices to provide the one or more items to a packaging station, and/or the like. In example embodiments, a packaging control system 30 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. In various embodiments, the packaging control system 30 may be in wired or wireless communication with one or more scanners 35 (e.g., barcode scanners, optical scanners, computer vision devices and/or the like) for identifying, sensing, and/or otherwise determining one or more items to be packed.

As will be recognized, these architectures and descriptions are provided for exemplary purposes only and are not limiting to the various embodiments.

### IV. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described above with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### V. CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus for controlling one or more packing material making machines, the apparatus comprising at least one processor and at least one memory storing computer program code, the at least one memory and the computer program code configured to, with the processor, cause the apparatus to at least:
store one or more predetermined packing recipes, wherein a packing recipe comprises (a) machine instructions for making a predetermined sequence of one or more packing materials and (b) a packaging solution for positioning the one or more packing materials in a container with an item, the packaging solution providing step-by-step instructions for positioning the one or more packing materials and the item within the container in accordance with the packaging solution;
select one of the one or more predetermined packing recipes based on received input;
cause a packing material making machine to make the sequence of one or more packing materials in accordance with the machine instructions of the selected packing recipe; and
provide the step-by-step instructions of the packaging solution to a user through a user interface.

2. An apparatus according to claim 1, wherein the at least one memory and the computer program code are further configured to, with the processor, cause the apparatus to at least receive user input (a) through the user interface and (b) selecting one of the one or more predetermined packing recipes.

3. An apparatus according to claim 1, wherein the at least one memory and the computer program code are further configured to, with the processor, cause the apparatus to at least receive input indicating an item to be packaged, wherein the selected packing recipe is selected from the one or more predetermined packing recipes based at least in part on the item to be packaged.

4. An apparatus according to claim 1, wherein the at least one memory and the computer program code are further configured to, with the processor, cause the apparatus to at least provide a next step of the step-by-step instructions of the packaging solution is provided in response to input received from the user through the user interface.

5. An apparatus according to claim 4, wherein the at least one memory and the computer program code are further configured to, with the processor, cause the apparatus to at least cause one of the packing material making machines to make one of the one or more packing materials to be used in a particular step when instructions for the particular step are being displayed by the user interface.

6. An apparatus according to claim 1, wherein the at least one memory and the computer program code are further configured to, with the processor, cause the apparatus to at least provide the step-by-step instructions of the packaging solution as a video.

7. An apparatus according to claim 1, wherein the machine instructions for making a sequence of one or more packing materials comprise machine instructions for making one or more packing materials and one or more delays between the one or more packing materials, such that a particular packing material is ready to be used when the user is expected to be ready to use the particular packing material.

8. An apparatus according to claim 1, wherein the at least one memory and the computer program code are further configured to, with the processor, cause the apparatus to at least receive a new recipe through a wired connection, a wireless connection, or both.

9. A method for controlling one or more packing material making machines, the method comprising:
storing one or more predetermined packing recipes, wherein a packing recipe comprises (a) machine instructions for making a predetermined sequence of one or more packing materials and (b) a packaging solution for positioning the one or more packing materials in a container with an item, the packaging solution providing step-by-step instructions for positioning the one or more packing materials and the item within the container in accordance with the packaging solution;
selecting one of the one or more predetermined packing recipes based on received input;
causing at least one of the packing material making machines to make the sequence of one or more packing materials in accordance with the machine instructions of the selected packing recipe; and
providing the step-by-step instructions of the packaging solution to a user through a user interface.

10. A method according to claim 9 further comprising receiving user input (a) through the user interface and (b) selecting one of the one or more predetermined packing recipes.

11. A method according to claim 9 further comprising receiving input indicating an item to be packaged, wherein the selected packing recipe is selected from the one or more predetermined packing recipes based at least in part on the item to be packaged.

12. A method according to claim 9, wherein a next step of the step-by-step instructions of the packaging solution is provided in response to input received from the user through the user interface.

13. A method according to claim 12 further comprising causing one of the packing material making machines to make one of the one or more packing materials to be used in a particular step while instructions for the particular step are being displayed through the user interface.

14. A method according to claim 9 further comprising providing the step-by-step instructions of the packaging solution as a video.

15. A method according to claim 9, wherein the machine instructions for making a sequence of one or more packing materials comprise machine instructions for making one or more packing materials and one or more delays between the one or more packing materials, such that a particular packing material is ready to be used when the user is expected to be ready to use the particular packing material.

16. A method according to claim 9 further comprising receiving a new recipe through a wired connection, a wireless connection, or both.

17. A computer program product for controlling one or more packing material making machines, the computer program product comprising at least one non-transitory computer-readable storage medium having computer-executable program code instructions stored therein, the computer-executable program code instructions comprising program code instructions configured to:
store one or more predetermined packing recipes, wherein a packing recipe comprises (a) machine instructions for making a predetermined sequence of one or more packing materials and (b) a packaging solution for positioning the one or more packing materials in a container with an item, the packaging solution providing step-by-step instructions for positioning the one or more packing materials and the item within the container in accordance with the packaging solution;
select one of the one or more predetermined packing recipes based on received input;
cause a packing material making machine to make the sequence of one or more packing materials in accordance with the machine instructions of the selected packing recipe; and
provide the step-by-step instructions of the packaging solution to a user through a user interface.

18. A computer program product according to claim 17, wherein the computer-executable program code instructions further comprise program code instructions configured to receive user input (a) through the user interface and (b) selecting one of the one or more predetermined packing recipes.

19. A computer program product according to claim 17, wherein the computer-executable program code instructions further comprise program code instructions configured to receive input indicating an item to be packaged, wherein the selected packing recipe is selected from the one or more predetermined packing recipes based at least in part on the item to be packaged.

20. A computer program product according to claim 17, wherein a next step of the step-by-step instructions of the packaging solution is provided in response to input received from the user through the user interface.

21. A computer program product according to claim 20, wherein the computer-executable program code instructions further comprise program code instructions configured to cause one of the packing material making machines to make one of the one or more packing materials to be used in a particular step while instructions for the particular step are being displayed through the user interface.

22. A computer program product according to claim 17, wherein the computer-executable program code instructions further comprise program code instructions configured to provide the step-by-step instructions of the packaging solution as a video.

23. A computer program product according to claim 17, wherein the machine instructions for making a sequence of one or more packing materials comprise machine instructions for making one or more packing materials and one or more delays between the one or more packing materials, such that a particular packing material is ready to be used when the user is expected to be ready to use the particular packing material.

24. A computer program product according to claim 17, wherein the computer-executable program code instructions further comprise program code instructions configured to receive a new recipe through a wired connection, a wireless connection, or both.
